(19) United States
(12) Patent Application Publication
(10) Pub. No.: US 2025/0253606 A1
(43) Pub. Date: Aug. 7, 2025

(54) FIBER SEGMENT AMPLIFIER ASSEMBLY

(71) Applicant: SUBCOM, LLC, Eatontown, NJ (US)

(72) Inventor: Andrew D. Meigs, Durham, CT (US)

(73) Assignee: SUBCOM, LLC, Eatontown, NJ (US)

(21) Appl. No.: 18/432,743

(22) Filed: Feb. 5, 2024

(51) Int. Cl. H01S 3/081; H01S 3/067

(52) U.S. Cl. CPC H01S 3/081; H01S 3/06754

(57) ABSTRACT

A fiber amplifier assembly may include an input fiber end, and an output fiber end, opposite to the input fiber end. The fiber amplifier assembly may further include a plurality of optical fiber segments, comprising at least one doped optical fiber segment, and arranged in a linear assembly, the plurality of optical fiber segments being mutually arranged to define an optical path between the input fiber end and the output fiber end. The fiber amplifier assembly may also include a reflector assembly, comprising a first set of reflectors arranged at the input fiber end, and a second set of reflectors, arranged at the output fiber end, wherein the first set of reflectors and second set of reflectors together with the plurality of optical fiber segments conduct a light signal traveling through the optical path between a pair of optical fibers.

### BACKGROUND

### Related Applications

### Field

Embodiments of the present disclosure relate to the field of optical communication systems. In particular, the present disclosure relates to techniques for improved repeaters and fiber amplifiers for repeaters.

### Discussion of Related Art

Optical communications systems, such as subsea optical communications systems may employ a series of fiber amplifiers to amplify optical signals along a subsea optical cable. A fiber-based amplifier typically utilizes several meters (5 m-30 m) of fiber. In common arrangements of a fiber amplifier, an optical fiber is coiled to reduce the size of the amplifier. To minimize an overall size of a fiber amplifier, the radius of the fiber coil is decreased to the smallest bend radius allowable for the desired fiber lifetime. Typically, the coil radius of the fiber coil lies in the 15 mm-20 mm range. This fiber radius, or more properly the related fiber diameter, has defined a lower limit to how small the overall fiber amplifier can be.

In one known approach, adhesive sheets are employed to hold a fiber coil in a planar configuration at a minimum thickness, which thickness is equal to the thickness of the fiber plus the adhesive sheet and film layer on either side of the fiber. Such thickness may approach 0.5 mm along a height direction (‘Z’-direction). However, the width and depth (along the respective X- and Y-directions) of the fiber coil package is still limited by the minimum bend radius of the fiber and the amount of fiber required for the amplifier (˜20 m). While this configuration represents a minimized volume for the fiber coil in the amplifier, packing multiple amplifiers of such a design is limited by the launch optics and collection optics. When creating a multi-channel amplifier based on such technologies, the advantage of the thin fiber coil, having a small height (<1 mm) is not realized, due to height of the ancillary components. Thus, other approaches to reducing fiber coil size and related overall size of the fiber amplifier may be useful.

It is with respect to these and other considerations that the present disclosure is provided.

### BRIEF SUMMARY

In one embodiment, a fiber amplifier assembly is provided. The fiber amplifier assembly may include an input fiber end, and an output fiber end, opposite to the input fiber end. The fiber amplifier assembly may further include a plurality of optical fiber segments, comprising at least one doped optical fiber segment, and arranged in a linear assembly, the plurality of optical fiber segments being mutually arranged to define an optical path between the input fiber end and the output fiber end. The fiber amplifier assembly may also include a reflector assembly, comprising a first set of reflectors arranged at the input fiber end, and a second set of reflectors, arranged at the output fiber end, wherein the first set of reflectors and second set of reflectors together with the plurality of optical fiber segments conduct a light signal traveling through the optical path between a pair of optical fibers.

In another embodiment, a fiber amplifier is provided. The fiber amplifier may include an optical pump unit to generate a pump signal; and a fiber assembly, where the fiber assembly includes an input fiber end, coupled to an input fiber, and an output fiber end, opposite to the input fiber end, and coupled to an output fiber. The fiber assembly may also include a plurality of optical fiber segments, arranged in a linear assembly, the plurality of optical fiber segments being mutually arranged to define an optical path between the input fiber end and the output fiber end. The fiber assembly may further include a reflector assembly, comprising a first set of reflectors arranged at the input fiber end, and a second set of reflectors, arranged at the output fiber end, wherein the first set of reflectors and second set of reflectors couple a light signal traveling through the optical path between the input fiber and the output fiber. As such, the pump signal may amplify the light signal during travel between the input fiber and the output fiber.

In another embodiment, a subsea optical communications system may include a first station, to launch an optical signal, a subsea optical cable, to conduct the optical signal, and at least one fiber amplifier, coupled in line with the optical cable. The at least one fiber amplifier may include and comprising an optical pump unit to generate a pump signal and a fiber assembly. The fiber assembly may include an input fiber end, coupled to an input fiber, an output fiber end, opposite to the input fiber end, and coupled to an output fiber, a plurality of optical fiber segments, arranged in a linear assembly, where the plurality of optical fiber segments are mutually arranged to define an optical path between the input fiber end and the output fiber end. The fiber assembly may also include a reflector assembly, comprising a first set of reflectors arranged at the input fiber end, and a second set of reflectors, arranged at the output fiber end. As such, the first set of reflectors and second set of reflectors may couple a light signal traveling through the optical path between the input fiber and the output fiber, wherein the pump signal amplifies the light signal during travel between the input fiber and the output fiber.

### BRIEF DESCRIPTION OF THE DRAWINGS

FIG. 1A depicts such a communications system, according to embodiments of the disclosure;

FIG. 1B shows an example of an amplifier, according to some embodiments of the disclosure;

FIG. 2 shows a variant of a fiber assembly, according to embodiments of the disclosure;

FIG. 3 depicts a fiber assembly, according to other embodiments of the disclosure;

FIG. 4A and FIG. 4B show the entrance face to a two different retroreflectors, respectively;

FIG. 5A shows a simplified view of an optical assembly;

FIG. 5B presents an optical representation of optical assembly of FIG. 5A;

FIG. 6 presents an embodiment of a fiber assembly having tow rows of fiber segments; and

FIG. 7 presents one embodiment of a central rod/optical fiber configuration for a fiber assembly.

### DESCRIPTION OF EMBODIMENTS

The present embodiments will now be described more fully hereinafter with reference to the accompanying drawings, in which exemplary embodiments are shown. The scope of the embodiments should not be construed as limited to the embodiments set forth herein. Rather, these embodiments are provided so that this disclosure will be thorough and complete, and will fully convey the scope of the embodiments to those skilled in the art. In the drawings, like numbers refer to like elements throughout.

Before detailing specific embodiments with respect to the figures, general features with respect to the embodiments will be reviewed. In accordance with embodiments of the disclosure, a novel fiber amplifier assembly, fiber amplifier, and communications architecture are provided, for use in a subsea optical communications system, for example. The fiber amplifiers of the present embodiments may be employed for any suitable application, including medical and telecommunications applications. The fiber amplifier assembly may be characterized by an input fiber end and an output fiber end, typically on the side opposite to the input fiber end. Between the input fiber end and output fiber end are disposed a plurality of optical fibers, arranged in a linear assembly, where the plurality of optical fibers are mutually arranged to define an optical path between the input fiber end and the output fiber end. The fiber amplifier assembly may further include a reflector assembly, comprising a first set of reflectors (meaning one or more retroreflectors) arranged at the input fiber end, and a second set of reflectors, arranged at the output fiber end, wherein the first set of reflectors and second set of reflectors couple light traveling through the optical path between a pair of optical fibers.

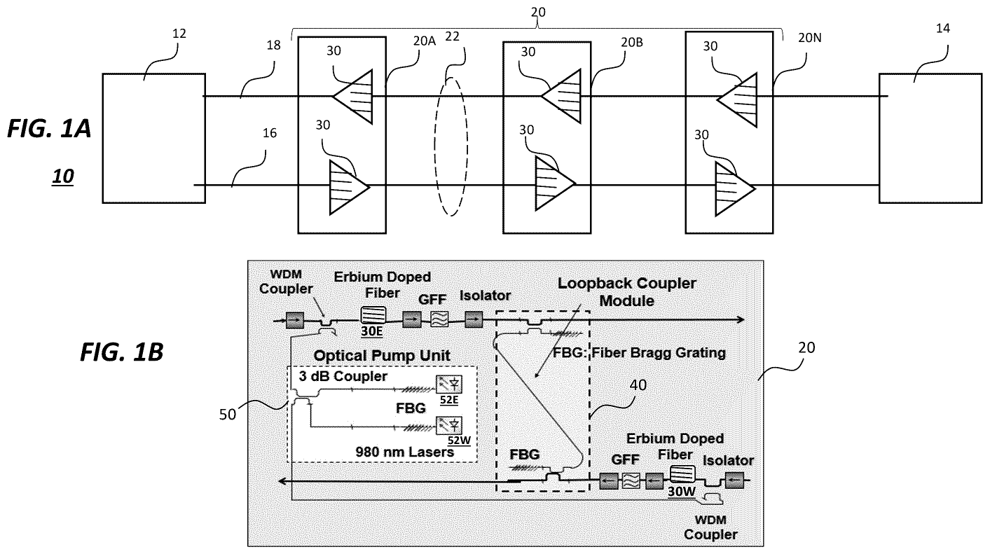

In various embodiments, a subsea optical communications system is provided, having a novel fiber amplifier assembly with improved design. FIG. 1A depicts such a communications system, shown as system 10. System 10 may include at least one optical repeater, which repeater may form part of a subsea optical communications system that spans hundreds of kilometers or up to several thousands of kilometers. The system 10 be employed, at least in part, to conduct bidirectional optical communications through optical fibers, as known in the art. As shown in FIG. 1A, the system 10 includes a pair of terminals that are shown as a first station 12, and a second station 14, where each of these stations may be terrestrial stations, and may be located at opposite ends to the system 10, in order to transmit and receive optical communications over a device, such as a cable. In some variants of the system 10, branching units may be provided, coupled to additional cable(s) that are connected to one or more additional terminals at the terrestrial end of said branching units, as known in the art. Bi-directional data transmission may be implemented by constructing pairs of optical fibers within a cable 22. In the example, shown, an optical fiber 16 may be arranged to conduct signals from ‘west’ to ‘east’ while an optical fiber 18 may be arranged to conduct signals from east to west. A series of optical amplifiers shown as amplifier 20A, amplifier 20B, and amplifier 20N^{th}, are arranged along a length of the system 10. The amplifiers 20A, 20B, . . . 20N^{th} may be spaced according to a series of spans that may have a length on the order of 50 km, 100 km, or similar distance. In some examples, the number of amplifiers and spans in the system 10 may be on the order of several dozen or more. In various embodiments of the system 10 of FIG. 1A, a given amplifier may be a doped fiber amplifier, such as an Erbium doped fiber amplifier (EDFA). Moreover, a given amplifier may be provided with, a pair of optical amplifier assemblies 30 that are collocated with one another to provide amplification for optical signals traveling from west to east via optical fiber 16 and from east to west via optical fiber 18. According to embodiments of the disclosure, the optical amplifier assemblies 30 may be provided with a special arrangement of a plurality of optical fibers as detailed herein below.

Note that while FIG. 1A depicts a simple topology of communications system, the present embodiments may be implemented in a linear system as generally depicted in FIG. 1A, or alternatively, may be implemented in a branched optical communications system that includes branching units and three or more terrestrial stations or terminals, as known in the art.

Turning to FIG. 1B there is shown an example of an amplifier 20, according to some embodiments of the disclosure. The amplifier 20 may include a first fiber assembly 30E for transmission of optical signals from west towards the east, and a second fiber assembly 30W, for transmission of optical signals from east towards the west. The amplifier 20 may include a loopback module 40 and an optical pump unit 50 to drive amplification of optical signals traveling through the first fiber assembly 30E and second fiber assembly 30W. The optical pump unit 50 may include a pair (or more) of lasers, shown as laser 52E, coupled to first fiber assembly 30E, and laser 52W, coupled to second fiber assembly 30W. The amplifier 20 may also include various couplers, gratings, and isolators, as shown. In order to reduce the overall size of the amplifier 20, according to embodiments of the disclosure, the first fiber assembly 30E and the second fiber assembly 30W may be arranged as a plurality of fibers, together with reflectors, as noted above, this architecture will be detailed herein below, but in brief will provide a fiber assembly that has an effective fiber length equivalent to the practical lengths provided by present day fiber coils, such as on the order of 10 m, 20 m, 30 m, and so forth, in a more compact arrangement than the known fiber coils.

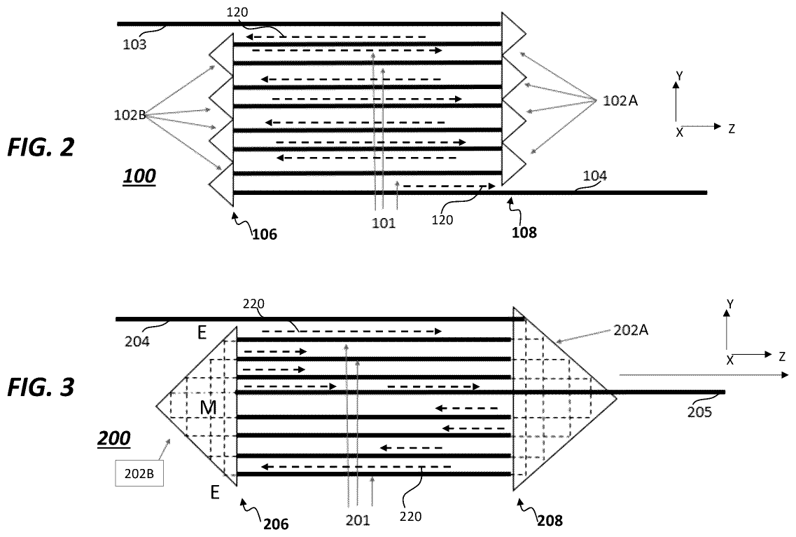

FIG. 2 shows a variant of a fiber assembly, shown as fiber assembly 100, according to embodiments of the disclosure. This embodiment shows one arrangement that is effective to achieve a smaller cross-sectional area as opposed to known fiber coils used in fiber amplifiers, such as EDFAs. Instead of providing a single fiber arranged in a coil, the fiber assembly 100 includes a plurality of short fibers, shown as fiber segments 101, that are arranged as short “sticks” (also referred to herein as “fiber segments” or “optical fiber segments”) whose length is on the order of several tens of centimeters. It may be understood that an “optical fiber segment” or “fiber segment,” as used herein, may refer to a doped optical fiber segment, made of a suitable fiber material for a fiber amplifier, such as a known erbium-doped fiber material. For example, in a fiber assembly such as fiber assembly 100, at least one of the fiber segments 101 will be a doped fiber segment, to ensure that the fiber assembly 100 acts properly as an optical amplifier. Note, however, that, in accordance with some embodiments, one or more fiber segments of a fiber assembly may be undoped. The fiber assembly 100 includes a pair of retroreflectors, where the retroreflectors may be referred to herein as a reflector assembly, which assembly may include one or more reflector sets, arranged on opposite ends of the plurality of fiber segments 101. In this embodiment, and other embodiments to follow the fiber assemblies, including a plurality of fibers joined to retroreflectors on opposite ends, presents a somewhat linear fiber amplifier shape, as opposed to a coil shape for known fiber amplifiers. In particular embodiments, the overall fiber amplifier structure has a pencil-like shape. In the example shown, a first reflector set 102A is arranged at the input fiber end 106, and a second reflector set 102B, arranged at the output fiber end 108, wherein the first reflector set 102A and second reflector set 102B couple light traveling through an optical path 120 (shown in dashed arrows) that extends between a pair of optical fibers that couple to the fiber assembly 100. These ‘external’ optical fibers are shown as delivery fiber 103 and exit fiber 104.

As shown, the first reflector set 120A and the second reflector set 102B are each formed of a plurality of reflectors, which may each be a collimation lens. For a given collimation lens a first fiber is coupled to transmit light (optical signal) to the collimation lens and a second fiber is coupled to receive light from the collimation lens. This arrangement caused the light to travel alternatively back and forth through the fiber assembly 100 from the input fiber end 106 to the output fiber end 108, ultimately exiting the fiber assembly 100 into the exit fiber 104.

While providing a potentially more compact arrangement of optical fibers, the fiber assembly 100 has a drawback in that the first reflector set 102A and the second reflector set 102B require a separate collimation lens for any given pair of fibers. Thus, the cross-sectional area of the fiber assembly 100 is defined by the rod lens cross-sectional area, packing fraction and the number of fiber ends. FIG. 3 depicts a fiber assembly 200, according to other embodiments of the disclosure. In this example, a first reflector set 202A and a second reflector set 202B are formed of a single reflector. Thus, on each of the input end 206 and output end 208, all of the optical fibers, show as fiber segments 201, are coupled to a single reflector. In this arrangement, light enters the fiber assembly 200 via delivery fiber 204 and is reflected by the first reflector set 202 where the light then enters the plurality of the fiber segments 201 and travels to the other second reflector set 203. After traversing the optical path 220 defined by the plurality of fiber segments 201, the amplified light exits the fiber assembly 200 to exit fiber 205. In this example, the optical path 220 proceeds from edges E of the respective reflector sets towards the middle M of the respective reflector sets before exiting to exit fiber 205.

Note that the depiction of fiber assembly 200 illustrates operation of reflector sets in two dimensions, showing a triangular shape in cross-section. Thus, in the depiction of FIG. 3, the reflective surface appears to be two sides of a triangle. In various embodiments, the reflective surface in a reflector set composed of a single retroflector (a common retroreflector, connected in common to all the fiver segments of the fiber assembly) may be any suitable two dimensional surfaces or three dimensional surfaces. For example, a retroreflector may be a graded refractive index (GRIN) rod reflector, a corner cube reflector, Cat-eye reflector (Catphote), according to some embodiments of the disclosure. In particular embodiments, instead of using a GRIN rod to collimate the light, a ball-lens, Fresnel lens, an axicon, or reflective optic could be used in its place. The reflective element could be one of several different optical elements from a mirror, a solid (prism) or hollow (open) retroreflector (2 or 3 reflections).

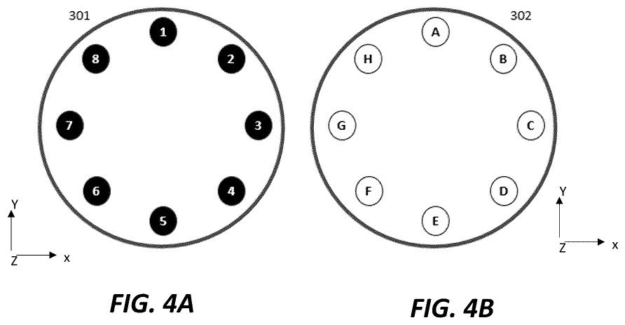

Turning to FIG. 4A and FIG. 4B there are shown the entrance face to a retroreflector 301 and entrance face to a retroreflector 302, respectively. In this example, each or the retroreflector 301 and retroreflector 302 includes a plurality of eight different reflection patches. The retroreflector 301 includes patches that are labeled as a series of locations “1” to “8,” while retroreflector 302 includes patches that are labeled as a series of locations “A” to “H.”

The shape of reflecting surfaces of retroreflector 301 may be arranged such that light entering the retroreflector 301 at Location 1 will emerge after reflection from a reflecting surface (not shown) at Location 5. Similarly, light entering the retroreflector 301 at location “2” will exit location “6”, “3” at “7”, “4” at “8” and vice-versa. In the example of FIG. 4A and FIG. 4B, for a simple routing arrangement, it may be posited that the plurality of fibers of a fiber bundle (in this case eight fibers) are constructed so that locations 1 to 8 are arranged to couple via a respective fiber to locations A to H, respectively. So, if an ordered bundle of fibers is placed between the two faces, meaning between retroreflector 301 and retroreflector 302, light entering the retroreflector 301 at location “1” emerges at location “5” from the retroreflector 301. The light then goes down a fiber that is disposed between the retroreflector 301 and retroreflector 302 to location “E” and is reflected out at location “A.” The light then travels towards location “1”, and continues for an endless loop back to location 5, which loop never “sees” the other locations (pathways).

Thus, in accordance with embodiments of the disclosure, the routings between locations on opposing retroreflectors are constructed in a more complex manner. In one embodiment, a fiber bundle (plurality of fibers) may be constructed having a combination of linear routings in half of a face of a retroreflector and a “clocked” combination of routings on the other half of the face. Thus, the routing protocol between the aforementioned locations of FIGS. 4A and 4B in one example may be “2” to “H”; “3” to “G”; “4” to “F”; “5” to “E”. But now instead of the aforementioned arrangement, the fibers are arranged so that location “8” is coupled to location “A”; “7” to “B”; “6” to “C”. Now when light is introduced at 1 the order becomes: 1→5, 5→E, E→A, A→8, 8→4, 4→F, F→B, B→7, 7→3, 3→G, G→C, C→6, 6→2, 2→H, H→D, D exits. All the underlined elements denote fiber connections. Thus, this clocked configuration provides a continuous path for light to enter and exit a fiber assembly.

In other embodiments, any ordering of the fiber sticks may be used, provided the resulting optical path through the fiber assembly has the desired gain (i.e. the path traverses all the fiber sticks).

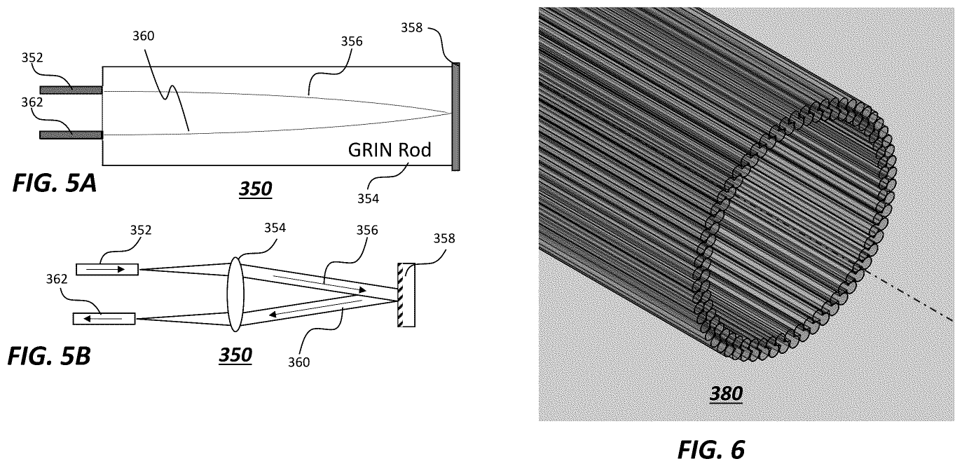

In order to properly route light from one fiber to another designated fiber as the light is reflected back and forth in a fiber assembly, a GRIN rod retroreflector may be employed as noted. In FIG. 5A there is shown a simplified view of an optical assembly 350, including an optical fiber 352 and GRIN rod 354. Note the GRIN rod 354 may be formed of a suitable known graded refractive index material that may exhibit a refractive index change within the GRIN rod 354, as known in the art. As light ray 356 travels from left to right through the optical fiber 352 the light ray 356 enters the GRIN rod 354 at a position towards the top, as shown, and is refracted along a curved path to a lower region in the GRIN rod 354. The light ray 356 may then be reflected back as reflected ray 360 from a reflecting surface 358, to travel to a different position along the GRIN rod 354 so as to enter a different fiber 362 in a return path from right to left. Thus, the GRIN rod 354 acts as a lens, as depicted in the optical representation of optical assembly 350, shown in FIG. 5B.

In accordance with embodiments of the disclosure, a retroreflector property may be tailored to include wavelength selection to allow pump injection, include wavelength selection for gain flattening, include an isolator (one-way), be tailored to affect polarization state of a light signal being transmitted. A mask at the interface between fiber segments and retroreflectors may provide spatial filtering, wavelength filtering, or polarization. The attachment between retroreflector and fiber bundle may be provided using an adhesive, fusion splice, or index matching fluid, according to some examples.

In accordance with further embodiments, the configuration of FIG. 4A and FIG. 4B can be expanded to include more fibers, and to include multiple layers of fiber. In this manner, according to an embodiment of the disclosure, 15 m of doped fiber may be broken up into one hundred 150 mm-long fibers. In an embodiment where 100 fibers are arranged as a single layer around a central rod and an individual optical fiber has a diameter of 250 microns, the outside diameter of the fiber bundle is ˜8.5 mm. In an embodiment where the fiber bundle is arranged as two rows as shown in the fiber assembly 380 of FIG. 6, the outside diameter becomes ˜5.5 mm; for an embodiment of three rows of fibers—4.75 mm. In accordance with still more embodiments, further size reductions are possible by using smaller diameter doped fiber. In this manner, the bundle of fiber ‘sticks’ in a fiber assembly may be made smaller than the retroreflector. This circumstance results in the size of an amplifier package being defined by the length of the fiber sticks and the cross-sectional area of the retroreflector. Note that in different embodiments, the fiber packing of a fiber assembly may be such that the input and output fibers exit the same end or opposite ends (even number vs odd number of fiber elements).

In accordance with further embodiments of the disclosure, a central rod may be provided as a support for a plurality of optical fibers, where the central “rod” is a glass member having similar mechanical properties (i.e. coefficient of thermal expansion) to the glass fibers. In such embodiments, the optical fiber “sticks” may be attached to the rod that acts as a central core, followed by polishing of both ends of the optical fiber/central rod structure, before retroreflectors are bonded to the optical fiber/central rod structure. The bonding may be done with an adhesive or fusion splicing. In some embodiments, it may be beneficial to employ a mask on both end-faces to limit the amount of stray light in the structure. These masks may be used as a spatial filter to improve the transverse mode properties of the amplified light.

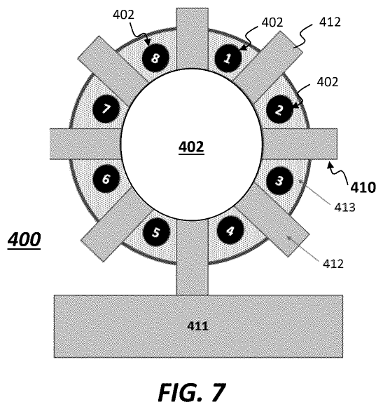

One embodiment of a central rod/optical fiber configuration for a fiber assembly is shown in FIG. 7. In this embodiment, a central rod 404 is provided, such as a glass rod. Around the central rod 404 are disposed a plurality of optical fibers, shown as fibers 402, where the positions of the different fibers are represented by the numbers 1-8. Note that in various embodiments, the number of optical fibers may be smaller or larger. In accordance with some embodiments, the central rod may be a central core that is composed of a glass, or a ceramic with coefficient of thermal expansion (CTE) matching the CTE of the fiber segments; a metal having a CTE and/or better heat transfer properties than fused silica; a metal or ceramic with appendages designed for heat transfer, or combinations of the above.

In some embodiments, as suggested in FIG. 7, a thermal conduction structure 410 may be incorporated into a fiber assembly 400. It may be advantageous to use a material with a high coefficient of thermal conduction for the thermal conduction structure 410. In particular embodiments, the thermal conduction structure 410 may include a plurality of fingers 412 that act as conductive fingers and surround adjacent ones of the fibers 402. The fingers 412 may, but need not, be arranged in alternating fashion with each of the fibers 402, as shown in FIG. 7. The thermal conduction structure 410 may thus assist in the dissipation of the heat generated in the fibers, and may be thermally coupled to an external mechanical member 411 to conduct that heat to the external mechanical member 411. In some embodiments, it may be advantageous to provide a thermal bonding adhesive 413 that surrounds the fibers 402 to further aid the heat transportation.

One drawback for implementing a fiber amplifier fiber assembly as an array of ‘sticks’ that are connected to pair of retroreflectors is that each fiber-retroreflector interface represents a loss, so additional gain requiring a source of gain to compensate for this loss, for example. However, one advantage appreciated by the present inventor is that of the arrangement of a plurality or individual sticks allows an individual doped fiber “stick” to have properties tailored to the location within the amplification sequence of that stick, rather than have all fibers having the same properties. Alternatively, in other embodiments, the fiber sticks for a given fiber assembly in a given amplifier may be selected from multiple draw lots (different levels and types of dopants and other process variations) so that the overall wavelength gain in the fiber assembly is a blend of the different lots. This latter “blended-lot” fiber assembly approach may be used to yield more consistent amplifier elements or, alternatively, amplifiers with tailored wavelength gain properties. Another possibility is that one of the sticks be replaced with a coupler segment, either as a pump injection site, as a mid-amplifier monitoring tap or for some other reason.

Moreover, the provision of retroreflectors as part of a fiber assembly provides the advantage that the reflection element within the retroreflector may have wavelength or polarization properties tailored to produce a more ideal output. In particular embodiments, the reflector wavelength properties could be such that the pump light enters through the reflector material of the reflection element. For example, if an erbium doped fiber amplifier for telecommunications is being designed, the reflectors may be made to reflect 100% of the 1550 nm wavelength photons, while allowing photons having the pump wavelength (i.e. 980 nm) to be fully transmitted.

While the aforementioned embodiments may be suitable for implementation with single mode fibers, in other embodiments, a multi-core fiber may be used in the fiber assemblies. Known multi-core fibers are formed of a single fiber body where in cross-section, the fiber body may include multiple separate regions that act as separate waveguides, for example, along the length of the fiber body. In some embodiments of a doped multi-core fiber (MCF), the individual optical fiber sticks may be rotated on their axis, so that each channel is be exposed to all the cores. For instance, in one particular embodiment where a 4-channel MCF is to be amplified, then in the first “stick” (fiber) Channel 1 may be in Core A, Channel 2 may be in Core B, etc. In the next segment (fiber), Channel 1 may be launched now Core B, Channel 2 in Core C, etc. In this manner, all channels may be exposed to portions of all the cores, thus increasing the amplification uniformity. Alternatively, the present embodiments cover configurations where the entire structure is constructed as a large MCF with multiple cores (single or multi-core) arranged around the perimeter as shown in FIG. 6. The “clocking” in such embodiments would be achieved by slightly twisting one end-face relative to the other end-face. In particular, to accomplish this clocking, a given core within a multi-core optical fiber segment will have a helical shape in three dimensions, such that the relative position of the given core on an input face of the fiber assembly will be displaced with respect to the relative position on the output face of the fiber assembly. In this manner, as an optical signal propagates back and forth through the fiber assembly, the different cores of the different optical fiber segments may be traversed. To clarify, in the case of a single core fiber and multiple layers of fiber, only one segment is needed to change the fiber from layer to layer. Likewise, for a MCF fiber, only one segment needs to be rotated so that each core in the MCF is traversed. For a 4-core MCF, if the light is launched into Core A, the light would transverse all the Core A segments until the light gets to the last segment before the input segment. In this last segment, a twist would need to occur, so that Core A on one face lines up with Core B on the other face. It is also possible to have the twist not be limited just to the last segment (discrete angular rotation), but small rotations distributed over all the fibers in the layer.

In further embodiments of the disclosure, rather than having a single coil made of a single fiber, the present fiber assembly design may be modified to provide for adjustment of dopant levels in different fibers of the fiber assembly, based on location in the amplification process. Such a design freedom has been lacking in known fiber amplifiers. Similarly, in some embodiments, an amplifier may be modified to provide for injection of the pump at different fibers, meaning at different points along the amplification process within a fiber assembly. Moreover, in some embodiments, the optical properties of the optical coatings of the retroreflector may be tailored for designed optical properties. For example, with tailoring of the optical coating properties of a retroreflector, the wavelength and polarization properties can be modified during the amplification sequence, which modification can be utilized to produce an improved response.

In further embodiments, the linear fiber assemblies of the present embodiments may be arranged for multi-stage amplification, where the fiber bundle making up the fiber assembly may be thought of as an N-stage amplifier, with N=number of fiber segments in the fiber bundle. In particular example, the fiber segments of the present embodiments may be used as a member of a 1×2 coupler or a 2×2 coupler for pump injection, monitoring or other uses. Examples of pump injection include injection with an input signal, distributed through a retroreflector, or distributed at fixed intervals or with varying power, through the end of a fiber segment, or as part of a fiber segment.

Using this logic, all of the common corrections that are done between stages (gain correction, modal shape enhancements, etc.) in processing of optical signals may also be employed within the N-stage “fiber bundle amplifier,” be it spatial filtering at the entrance and exit faces of the retroreflectors, the use of non-doped fibers with differing characteristics, such as cladding mode suppression or wavelength or polarization selection, and so forth.

In still further embodiments of the disclosure, one or more of the doped fiber segments may be replaced or augmented by other types of fiber, such as un-doped fiber for space filling, cladding mode suppressing fiber, polarization maintaining fiber, etc., where these replacement or new segments serve to improve the quality of the amplified light.

In additional embodiments, the fiber assembly structure may be used to create a compact time-delay line. This structure could may be used any time a fixed coil is needed. In some embodiments of the disclosure, a fiber assembly including a fiber bundle (plurality of fiber segments), return method (retro-reflector) and core (such as central rod) may be used as a stand-alone element and connected (spliced) with other optics as a discrete, free-space setup. In some embodiments, the fiber bundle, return method and core may be integrated with a micro-optic bench containing other elements, such as the pump combiner, isolators, gain flattening filters, monitoring photodiodes and/or high-loss loop-back structures (a monolithic structure).

### SUMMARY AND ADVANTAGES

The present embodiments are especially suitable for implementation in fiber amplification designs having a smaller size, with a focus on miniaturization, specifically, in increasing the density or compactness of the fiber amplifier. Non-limiting examples of amplifiers that employ the present embodiments include single mode doped fiber amplifiers, single mode erbium doped fiber amplifiers (EDFA), multi-core doped fiber amplifiers, and multi-core erbium doped fiber amplifiers (MC-EDFA).

For example, prior fiber amplifier devices based upon coiled fibers have been disclosed having dimensions that total approximately 18,000 mm³. In the present embodiments, an amplifier design based upon fiber ‘stick’ arrays with retroreflectors may be reasonably constructed with orthogonal dimensions of 8 mm×8 mm×170 mm, or 12,000 mm³ volume, a reduction of 33%. By implementing such a design with this square cross-section, improved system packaging is enabled. In some applications, known fiber amplifiers may be installed in a ˜19″ equipment rack, where depth is a relatively “free” variable and the front panel real-estate is a premium. Therefore, having a complete amplifier design that is on the order of and smaller than an input and output connector is highly desirable. This packaging also allows for in-line or in-cord amplifier design—a potential benefit in the medical and telecommunication applications.

With the fiber assembly design of the present embodiments, employing multiple fibers arranged between reflector assemblies, several other advantages obtain. Rather than having a single coil made of a single fiber, the present fiber assembly design allows for easy adjustment of dopant levels in different fibers of the fiber assembly, based on location in the amplification process. Such as design freedom has been lacking in known fiber amplifiers. Similarly, the fiber assembly architecture of the present embodiments provides an easy means to inject the pump at multiple points along the amplification process, which injection point flexibility is a new design freedom. Moreover, since the retroreflector's optical coatings may be tailored for designed optical properties, the retroreflector coating present a further new design variable. For example, with tailoring of the optical coating properties of a retroreflector, the wavelength and polarization properties can be modified during the amplification sequence, which modification can be utilized to produce an improved response.

Herein, novel and inventive apparatus, systems, structures, and techniques for providing a more compact and flexible fiber amplifier design are provided.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation, in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A fiber amplifier assembly, comprising:
an input fiber end;
an output fiber end, opposite to the input fiber end;
a plurality of optical fiber segments, comprising at least one doped optical fiber segment, and arranged in a linear assembly, the plurality of optical fiber segments being mutually arranged to define an optical path between the input fiber end and the output fiber end; and
a reflector assembly, comprising a first reflector set arranged at the input fiber end, and a second reflector set, arranged at the output fiber end, wherein the first reflector set and the second reflector set together with the plurality of optical fiber segments conduct a light signal traveling through the optical path between a pair of optical fibers.

2. The fiber amplifier assembly of claim 1, wherein: the first reflector set comprising a first plurality of retroreflectors and the second reflector set comprising a second plurality of retroreflectors.

3. The fiber amplifier assembly of claim 1, the first reflector set comprising a first common retroreflector, coupled to an entirety of the plurality of optical fiber segments, and the second reflector set comprising a second common retroreflector, coupled to the entirety of the plurality of optical fiber segments.

4. The fiber amplifier assembly of claim 3, the first common retroflector and the second common retroreflector comprising a prism shape.

5. The fiber amplifier assembly of claim 3, the first common retroreflector and the second common retroreflector comprising a graded refractive index material having a rod shape.

6. The fiber amplifier assembly of claim 3, wherein the plurality of optical fiber segments are mutually arranged in a circular pattern in cross-section.

7. The fiber amplifier assembly of claim 6, further comprising a central rod, wherein the plurality of optical fibers are arranged around the central rod.

8. The fiber amplifier assembly of claim 7, further comprising a plurality of conductive fingers, arranged around a perimeter of an outer surface of the central rod, wherein the plurality of optical fiber segments are arranged between the conductive fingers.

9. The fiber amplifier assembly of claim 3, wherein the first common retroreflector and the second common retroreflector comprise a reflection element, wherein the reflection element is configured to reflect radiation at a first wavelength, and to fully transmit radiation at a second wavelength, the second wavelength corresponding to a pump wavelength of a laser that is coupled to the fiber amplifier assembly.

10. The fiber amplifier assembly of claim 1, wherein the plurality of optical fibers are selected from a plurality of different fiber lots.

11. The fiber amplifier assembly of claim 1, wherein a set of optical properties for a given fiber segment of the plurality of optical fiber segments is tailored according to a position of the given fiber segment along the optical path.

12. The fiber amplifier assembly of claim 1, wherein at least one fiber segment of the plurality of optical fiber segments is not doped.

13. The fiber amplifier assembly of claim 6, wherein at least one optical fiber segment of the plurality of optical fiber segments is a multi-core fiber segment.

14. The fiber amplifier assembly of claim 1, wherein at least one optical fiber segment of the plurality of optical fiber segments is a multi-core fiber segment.

15. A fiber amplifier comprising, comprising:
an optical pump unit to generate a pump signal; and
a fiber assembly, comprising:
an input fiber end, coupled to an input fiber;
an output fiber end, opposite to the input fiber end, and coupled to an output fiber;
a plurality of optical fiber segments, arranged in a linear assembly, the plurality of optical fiber segments being mutually arranged to define an optical path between the input fiber end and the output fiber end; and
a reflector assembly, comprising a first reflector set arranged at the input fiber end, and a second reflector set, arranged at the output fiber end, wherein the first reflector set and second reflector set couple a light signal traveling through the optical path between the input fiber and the output fiber, and
wherein the pump signal amplifies the light signal during travel between the input fiber and the output fiber.

16. The fiber amplifier of claim 15, the first reflector set comprising a first common retroreflector, coupled to an entirety of the plurality of optical fiber segments, and the second reflector set comprising a second common retroreflector, coupled to the entirety of the plurality of optical fiber segments.

17. The fiber amplifier of claim 16, the first common retroreflector and the second common retroreflector comprising a graded refractive index material having a rod shape.

18. A subsea optical communications system, comprising:
a first station, to launch an optical signal;
a subsea optical cable, to conduct the optical signal; and
at least one fiber amplifier, coupled in line with the subsea optical cable, and comprising:
an optical pump unit to generate a pump signal; and
a fiber assembly, comprising:
an input fiber end, coupled to an input fiber;
an output fiber end, opposite to the input fiber end, and coupled to an output fiber;
a plurality of optical fiber segments, arranged in a linear assembly, the plurality of optical fiber segments being mutually arranged to define an optical path between the input fiber end and the output fiber end; and
a reflector assembly, comprising a first reflector set arranged at the input fiber end, and a second reflector set, arranged at the output fiber end, wherein the first reflector set and the second reflector set couple a light signal traveling through the optical path between the input fiber and the output fiber, and
wherein the pump signal amplifies the light signal during travel between the input fiber and the output fiber.

19. The subsea optical communications system of claim 18, the first reflector set comprising a first common retroreflector, coupled to an entirety of the plurality of optical fiber segments, and the second reflector set comprising a second common retroreflector, coupled to the entirety of the plurality of optical fiber segments.

20. The subsea optical communications system of claim 19, the first common retroreflector and the second common retroreflector comprising a graded refractive index material having a rod shape.
